(19) United States
(12) Patent Application Publication
(10) Pub. No.: US 2025/0300684 A1
(43) Pub. Date: Sep. 25, 2025

(54) COMMUNICATION USING MODULATED THERMAL NOISE

(71) Applicant: University of Washington, Seattle, WA (US)

(72) Inventors: Joshua R. Smith, Seattle, WA (US); Zerina Kapetanovic, Seattle, WA (US)

(21) Appl. No.: 18/638,492

(22) Filed: Apr. 17, 2024

Related U.S. Application Data
(63) Continuation-in-part of application No. PCT/US2022/079901, filed on Nov. 15, 2022.
(60) Provisional application No. 63/264,084, filed on Nov. 15, 2021.
(60) Provisional application No. 63/460,518, filed on Apr. 19, 2023.

(51) Int. Cl. H04B 1/04

(52) U.S. Cl. CPC H04B 1/0475

(57) ABSTRACT

This disclosure describes examples of systems, apparatuses, and methods for performing wireless communication using thermal noise of one or more components of the systems. An example method includes modulating thermal noise in a transmitter based on data to provide a signal and transmitting the signal including the data as output of the transmitter.

### CROSS-REFERENCE TO RELATED APPLICATIONS

This application claims priority under 35 U.S.C. § 119 to U.S. Provisional Application No. 63/460,518 filed Apr. 19, 2023. This application is a continuation-in-part of international patent application PCT/US2022/079901 filed Nov. 15, 2022, which PCT application claims priority to U.S. Provisional Application No. 63/264,084 filed Nov. 15, 2021. The entire contents of the aforementioned applications are incorporated herein by reference in their entirety for any purpose.

### STATEMENT REGARDING RESEARCH AND DEVELOPMENT

This invention was made with government support under Grant No. CNS1823148, awarded by the National Science Foundation. The government has certain rights in the invention.

### BACKGROUND

Wireless communication generally refers to a transfer of information between two or more points without using an electrical conductor, an optical fiber, or another continuous guided medium for the transfer of the information. Some wireless technologies use radio waves or radio frequency (RF) signals. One way to reduce the power needed to perform wireless communication is by performing passive wireless communication.

In passive wireless communication, an energy-constrained data transmitter can send information by modulating an RF signal generated by an RF source that is not power constrained. Since in passive wireless communication the data transmitter does not necessarily need to generate an RF signal, the power needed to send data using passive wireless communication is generally less than in conventional wireless or RF communication. For example, in modulated backscatter communication, a continuous wave RF carrier or signal is generated by a dedicated device on a high-power side of a link, and a low-power side of the link encodes data by selectively reflecting the RF signal. Ambient backscatter is another example form of passive wireless communication, and ambient backscatter utilizes pre-existing or ambient RF signals, such as RF signals generated by broadcast television (TV) towers or radio towers.

Low-power radio communication devices designed to emit signals in response to a received broadcast signal-as with radio frequency identification (RFID) tags-are widely used to identify and locate items. Their circuitry uses power to be harvested from another ambient RF carrier signal, be it a signal from the RF reader itself or a nearby source of sufficient RF power—like a television broadcasting tower. A conventional RFID tag retransmits its signal by backscattering the carrier signal-a version of the carrier signal modulated by toggling the antenna on the chip between reflecting and absorbing the carrier signal, or matched and mismatched impedance states. Because the RFID tag uses a carrier signal in order to generate any readable signal of its own, such RFID tag's signal transmission depends on external power sources.

### SUMMARY

Examples of methods for performing wireless communication using thermal noise of one or more electronic components are disclosed herein. An example method includes modulating thermal noise in a transmitter based on data to provide a signal, and transmitting the signal including the data as output of the transmitter.

In some examples, the transmitter includes an antenna, and said transmitting the signal is performed wirelessly using the antenna. In some examples, said modulating the thermal noise includes modulating a signal intensity of the signal at least in part based on the data.

In some examples, the method includes coupling an output node of the transmitter to at least one electronic component in the transmitter responsive to each bit of the data having a first binary value, and decoupling the output node from the electronic component responsive to each bit of data having a second binary value, where the thermal noise includes thermal noise of the at least one electronic component. In some examples, said decoupling includes coupling the output node to a reference voltage. In some examples, a first impedance of the transmitter to the output node when the output node is coupled to the at least one electronic component is a closer impedance match than a second impedance of the transmitter to the output node when the output node is decoupled from the at least one electronic component. In some examples, the signal during the second state has a lower signal intensity than the signal during the first state.

In some examples, the method includes receiving an external signal from a receiver, where the thermal noise includes thermal noise based on the external signal. In some examples, the method includes receiving an external signal from a receiver, and modulating the thermal noise to provide the signal representing data responsive to the external signal indicative of a thermal noise mode. In some examples, the method includes transmitting the signal when the external signal being a time-multiplexed continuous wave signal is absent. In some examples, the method includes transmitting the signal at a frequency different from a frequency of the external signal.

Examples of apparatuses are disclosed herein. An example apparatus includes at least one electronic component, a controller that modulates thermal noise from the at least one electronic component to provide a signal representing data, and a transmitter that transmits the signal at an output node.

In some examples, the electronic component includes a resistor. In some examples, the controller includes a subcarrier generator that generates a subcarrier frequency, and where the controller is configured to modulate the thermal noise further based on the subcarrier frequency. In some examples, the apparatus further includes an antenna coupled to the output node, where the transmitter wirelessly transmits the signal through the antenna.

In some examples, the apparatus further includes a harvester that harvests energy and provides power based on the harvested energy, where the controller modulates the power to provide a signal representing data. In some examples, the harvester includes one or more photovoltaic cells.

In some examples, the apparatus further includes a switch coupled to an output node, where the controller provides a control signal based on each bit of the data, and where the switch couples the output node to the at least one electronic component responsive to the control signal based on each bit of the data having a first binary value in a first state, and further decouples the output node from the at least one electronic component responsive to the control signal based on each bit of data having a second binary value in a second state. In some examples, the switch selectively changes an impedance matching of the apparatus responsive to the control signal. In some examples, the electronic device is coupled between the switch and a reference voltage node. In some examples, the switch decouples the electronic component from the output node when the switch is in a first state, and further couples the electronic component to the output node when the switch is in a second state. In some examples, the switch couples the output node to a reference voltage when the switch is in the first state. In some examples, the thermal noise includes thermal noise caused by the harvester.

In some examples, the apparatus includes a receiver that receives an external signal, where the controller modulates thermal noise to provide a signal representing data responsive to the external signal indicative of a thermal noise mode, and where the controller further modulates a carrier signal in the external signal to provide a signal representing the data responsive to the external signal indicative of a radio frequency mode. In some examples, the external signal is a time-multiplexed continuous wave signal, and where the transmitter provides the signal representing data while the external signal is absent.

Examples of apparatuses are disclosed herein. An example apparatus includes a first receiver circuity that includes a first antenna that receives a first signal, a second receiver circuity that includes a second antenna that receives a second signal, and at least one power level detector that digitizes a signal based on the first signal or the second signal into a digital signal, where the at least one power level detector detects power fluctuations based on a power level range of the second signal that is smaller than a power level range of the first signal.

In some examples, the apparatus includes where each receiver circuitry further includes a low noise amplifier coupled to at least one of the first antenna and the second antenna, the low noise amplifier configured to amplify the received signal, and a processor configured to decode the digital signal to provide the data, where the amplified signal is the signal based on the first signal or the second signal. In some examples, the apparatus includes where the receiver is configured to perform a heterodyne detection of the data.

Examples of systems are disclosed herein. An example system includes a transmitter that transmits a signal with data by using a subcarrier frequency, where the transmitter modulates a thermal noise of the transmitter and modulates a signal intensity of the transmitted signal in accordance with the data, and a receiver receives the signal with the data by using the subcarrier frequency, where the receiver demodulates the signal intensity of the received signal with the data by comparing the signal intensity to a threshold signal intensity.

In an embodiment of the disclosure, a method includes controlling a switch between a first state of the switch to couple an electronic component to an antenna and present a first impedance to the antenna, and a second state of the switch to present a second impedance to the antenna, where the first impedance is a closer impedance match to the antenna than the second impedance, and where the controlling is performed in accordance with a subcarrier frequency and data to modulate thermal noise of a transmitter including the at least one electronic component to transmit a signal including the data.

Additionally, or alternatively, where said transmit the signal includes transmitting the signal wirelessly using the antenna.

Additionally, or alternatively, where the antenna is coupled to the electronic component in the first state and decoupled from the electronic component in the second state.

Additionally, or alternatively, where the first state of the switch couples the electronic component between the antenna and a reference voltage node.

Additionally, or alternatively, where the signal during the second state has a lower signal intensity than the signal during the first state.

Additionally, or alternatively, where the lower signal intensity during the second state corresponds to a first binary value of the data.

Additionally, or alternatively, where the second state of the switch causes an open circuit.

Additionally, or alternatively, where each bit of the data includes the first binary value or a second binary value, and where the modulating of a thermal noise includes modulating a signal intensity of the transmitted signal including the data.

Additionally, or alternatively, the method further includes generating a control signal, using a controller, by encoding the data using the subcarrier frequency.

Additionally, or alternatively, where the first impedance includes a matched impedance to the antenna.

Example apparatuses for performing wireless communication using thermal noise of one or more electronic components are disclosed herein. In an embodiment of the disclosure, an apparatus may include an antenna. The apparatus may also include an electronic component with an electronic component impedance. The apparatus may also include a switch coupled to the electronic component and the antenna. The apparatus may also include a controller coupled to the switch, and the controller may include a subcarrier generator configured to generate a subcarrier. The controller is configured to generate a control signal based on the subcarrier and data, and where the controller is further configured to provide the control signal to the switch to control the switch to selectively change an impedance matching of the apparatus to modulate a thermal noise of the apparatus to transmit a signal including the data.

Additionally, or alternatively, where the apparatus includes a transmitter configured to wirelessly transmit the data without a carrier signal.

Additionally, or alternatively, where the switch includes a single-pole single-throw (SPST) switch, and where: an open state of the SPST switch electrically disconnects the electronic component from the antenna; and a closed state of the SPST switch electrically connects the electronic component to the antenna.

Additionally, or alternatively, the switch includes a single-pole double-throw (SPDT) switch, and where: a first state of the SPDT switch electrically connects the electronic component to the antenna; and a second state of the SPDT switch electrically connects the antenna to a ground node.

Additionally, or alternatively, where the electronic component includes a resistor.

Additionally, or alternatively, where the electronic component is coupled between the switch and a direct current (DC) voltage node.

Additionally, or alternatively, where the DC voltage node includes a ground node.

Example systems for performing wireless communication using thermal noise of one or more electronic components are disclosed herein. In an embodiment of the disclosure, a system includes a transmitter for transmitting a signal with data by using a subcarrier frequency, where the transmitter is configured to modulate a thermal noise of the transmitter and modulate a signal intensity of the transmitted signal in accordance with the data. The system may also include a receiver for receiving the signal with the data by using the subcarrier frequency, where the receiver is configured to demodulate the signal intensity of the received signal with the data by comparing the signal intensity to a threshold signal intensity.

Additionally, or alternatively, where the receiver performs a heterodyne detection of the data.

Additionally, or alternatively, where the receiver includes at least a low noise amplifier, a power level detector, and a processor.

### BRIEF DESCRIPTION OF THE DRAWINGS

FIG. 1 is a schematic diagram of a system with a transmitter and a receiver, in accordance with examples described herein.

FIG. 2A illustrates an example graph of a square-wave subcarrier, in accordance with examples described herein.

FIG. 2B illustrates an example graph of a data packet to be encoded and modulated by the transmitter, in accordance with examples described herein.

FIG. 2C illustrates an example graph of an encoded and modulated data packet by the transmitter, where an encoded data packet is used to selectively control a switch of the transmitter, in accordance with examples described herein.

FIG. 3 illustrates an example environment of one or more transmitters communicating data wirelessly with one or more receivers, in accordance with examples described herein.

FIG. 4 shows a list of equations, having a first equation, a second equation, a third equation, and a fourth equation, where the list of equations is referred to at the appropriate portions of the text herein.

FIGS. 5A and 5B are schematic diagrams of a transmitter, in accordance with examples described herein.

FIG. 6 is a schematic diagram of a receiver, in accordance with examples described herein.

### DETAILED DESCRIPTION

This disclosure includes examples of systems, apparatuses, and methods for performing wireless communication using thermal noise of one or more components. Using thermal noise, examples of the disclosed systems, apparatuses, and methods may perform passive wireless communication. Conventional, existing, and/or previously described and/or developed passive wireless communication may include modulated backscatter communication and ambient backscatter communication. However, passive wireless communication using modulated backscatter communication and/or ambient backscatter communication, at least and/or in part, rely on an RF signal generated by an RF source or on one or more pre-existing RF signals. These RF signals may be utilized as carrier signals during wireless communication.

By contrast, examples of the disclosed systems, apparatuses, and methods may perform wireless passive communication without relying on pre-existing RF signals and/or without using a carrier signal in some examples. By so doing, examples of systems, apparatuses, and methods described herein may be deployed in remote areas that may be away from a television (TV) tower, a radio tower, or another ambient backscatter and/or RF signal generator. Examples of disclosed systems, apparatuses, and methods described herein may perform passive wireless communication while reducing power consumption and/or conserving power compared to other conventional solutions.

In some examples, ultra-high frequency (UHF) RFID tags may be read without using a carrier signal. In some examples, a reader may read a signal from an RFID tag without emitting a carrier signal. In addition to modulating a carrier signal, a backscatter modulator circuit in the RFID tag may modulate tag circuit noise, including Johnson noise, present in a tag even if a carrier signal is absent. A signal provided using a modulated noise communication (MNC) technique may be read by a reader for MNC. In some examples, the reader for MNC may be simpler than a conventional backscatter reader from circuitry viewpoints because the reader for MNC may be free from self-interference. The tag may need an alternative power source in absence of a carrier signal. In some examples, the tag may include an energy harvester including a photovoltaic cell. In some examples, the tag may use a time-multiplexed continuous wave signal from the reader. The use of time multiplexing may prevent self-interference by the reader.

In some examples, ultra-high frequency (UHF) RFID tags may be read without using a carrier signal. In some examples, a reader may read a signal from an RFID tag without emitting a carrier signal. In addition to modulating a carrier signal, a backscatter modulator circuit in the RFID tag may modulate tag circuit noise, including Johnson noise, present in a tag even if a carrier signal is absent. A signal provided using a modulated noise communication (MNC) technique may be read by a reader for MNC. In some examples, the reader for MNC may be simpler than a conventional backscatter reader from circuitry viewpoints because the reader for MNC may be free from self-interference. The tag may need an alternative power source in absence of a carrier signal. In some examples, the tag may include an energy harvester including a photovoltaic cell. In some examples, the tag may use a time-multiplexed continuous wave signal from the reader. The use of time multiplexing may prevent self-interference by the reader.

While examples of advantages of systems, apparatuses, and methods described herein are described to facilitate an appreciation of the technology described, it is to be understood that the systems, apparatuses, and/or methods may have all, or even any, of the described advantages.

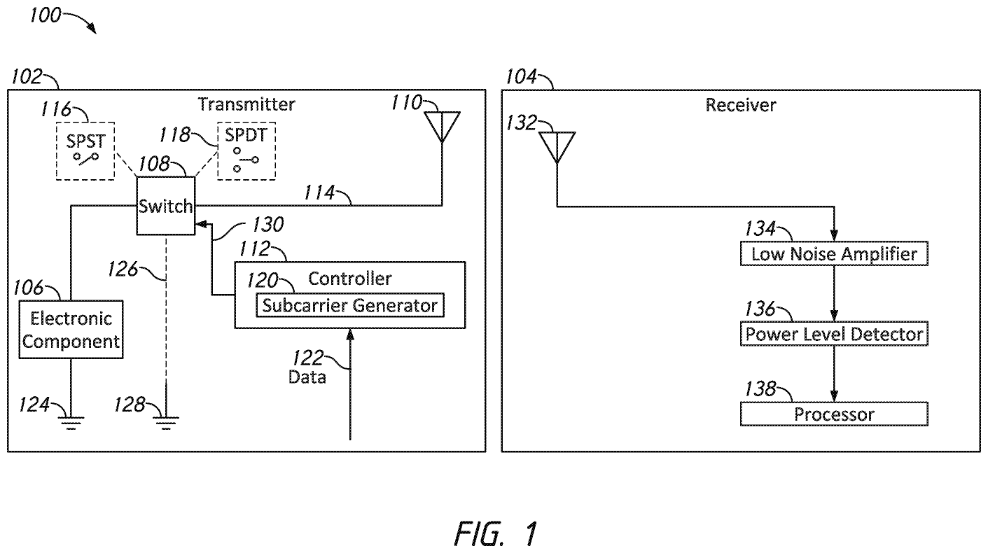

FIG. 1 is a schematic illustration of a system 100 including a transmitter 102 and a receiver 104 in accordance with examples described herein. Generally, the system 100 may communicate data wirelessly between the transmitter 102 and the receiver 104 by modulating thermal noise that is associated with electrical component(s) (e.g., an electronic component(s) 106) of the transmitter 102, in accordance with examples described herein. The transmitter 102 includes an antenna 110, a switch 108, an electronic component 106, and a controller 112. The controller 112 may include a subcarrier generator 120. Two example implementations of switch 108 are depicted in FIG. 1—an SPST switch 116 and an SPDT switch 118. The switch 108 may be controlled by the controller 112 to make connections between the antenna 110, the electronic component 106, and/or a reference voltage 128. The controller 112 may control the switch 108 in accordance with data 122 provided to the controller 112. The switch 108 may accordingly couple different impedance values to the antenna 110 depending on the position of the switch 108 in some examples.

The receiver 104 may include an antenna 132, a low noise amplifier 134, a power level detector 136, and a processor 138.

The components shown in FIG. 1 are exemplary only. Additional, fewer, and/or different components may be used in other examples.

Thermal noise, which may also be referred to as Johnson-Nyquist noise, Johnson noise, or Nyquist noise, generally refers to noise caused by thermal vibrations of charge carriers (e.g., electrons, holes) inside an electrical conductor having a resistance (or impedance). Generally, thermal noise occurs regardless of any applied voltage, and thermal noise may be present in electrical conductors, electrical circuits, and/or electronic components. Often, engineers and scientists strive to mitigate thermal noise, because, in some frequency operations, thermal noise may distort, introduce undesired noise, and/or weaken communication signals. By contrast, examples described herein, such as the system 100, may take advantage of the thermal noise to wirelessly transmit data from the transmitter 102 to the receiver 104.

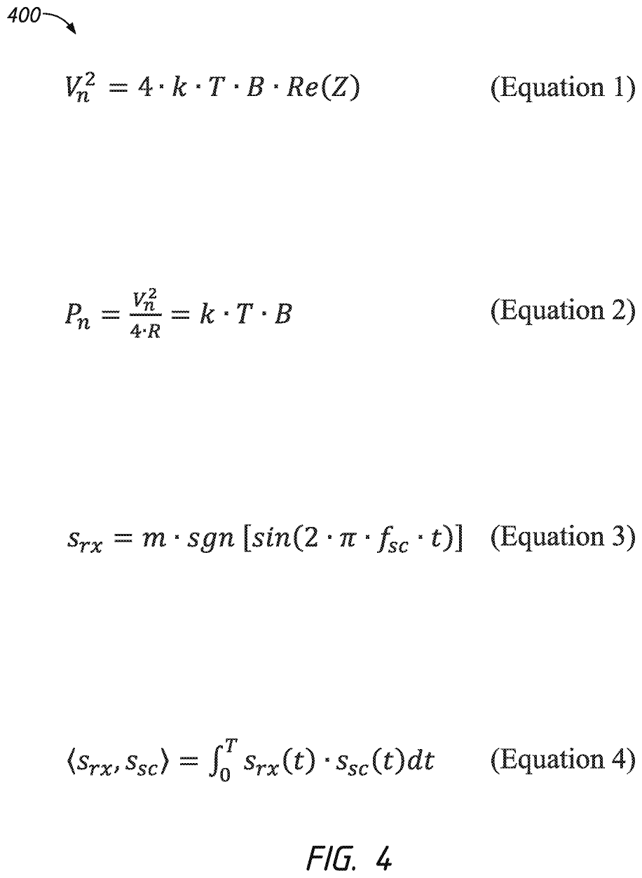

In some examples, thermal noise of, for example, an electrical conductor, an electrical circuit, and/or an electronic component may be expressed, characterized, calculated, and/or defined using Equation 1, where Equation 1 is shown in FIG. 4. In Equation 1 of FIG. 4, Vₙ² denotes the mean-squared voltage of thermal noise; k denotes the Boltzmann's constant; T denotes the temperature; B denotes the bandwidth; and Re(Z) denotes the real part (Re) of the impedance (Z) of the example electrical conductor, electrical circuit, and/or electrical component. Generally, any electronic component having an impedance may have thermal noise and may be used to transmit signals in accordance with methods described herein. The electronic component 106 may accordingly be implemented by one or more resistors, conductors, inductors, or generally any component having an impedance.

In some examples, the transmitter 102 includes an electronic component(s) 106, a switch 108, a transmit antenna(s) 110, and a controller 112. In FIG. 1, the electronic component(s) 106 is coupled to a ground 124 node (“ground 124”). Although not illustrated as such, instead of being coupled to ground 124, the electronic component(s) 106 may be coupled to another reference node, such as a direct current (DC) voltage node, such as a VDD node, a VCC node, or a node with a negative DC voltage. Therefore, the illustrated coupling of the electronic component(s) 106 to ground 124 is a non-limiting example design. Nevertheless, to limit or reduce power consumption, manufacturing cost, size, and/or complexity of the transmitter 102, in some examples, it may behoove a circuit designer to couple the electronic component(s) 106 to ground 124, as is illustrated in FIG. 1.

The electronic component(s) 106 may be a resistor (R); a diode; a transistor; a network of inductors (Ls), capacitors (Cs), and/or resistors (Rs); and/or any other electronic component(s) that includes a resistance (or an impedance).

In some examples, the electronic component(s) 106 may be implemented using a resistance that may be implemented in a variety of ways. For example, the resistance (e.g., the electronic component(s) 106) may be implemented in an integrated circuit (IC). As another example, the resistance may be implemented using one or more diodes. As another example, the resistance may be implemented as a Schottky diode (e.g., a metal-semiconductor junction). As another example, the resistance may be implemented as a diode-connected transistor or a transistor having another configuration. As another example, the resistor may be carbon, silver, or another conductive/resistive ink that may be printed on a substrate or other surface. As another example, the resistance may be implemented using a sensor, such as a photoresistor or a carbon microphone, whose resistance changes in proportion to another physical quantity to be transduced or sensed. As yet another example, the resistance may be implemented using an electrolyte, such as seawater, freshwater, or a fluid inside or associated with a human body.

In some examples, the electronic component(s) 106 may be implemented using a plurality of resistors that are coupled in a parallel configuration. As such, disconnecting one or more resistors of the plurality of resistors may increase the overall resistance of the electronic component(s) 106. In some examples, the electronic component(s) 106 may be a network of RLC circuit elements, which are passive or unpowered circuit elements. As such, various configurations of the RLC circuit elements may result in various overall resistances of the electronic component(s) 106.

The resistance (or the impedance) of the electronic component(s) 106 affects an impedance matching of the transmitter 102. In aspects, the resistance with thermal noise may be modeled as a Thevenin equivalent circuit that includes a noiseless resistor and a noise voltage generator with a voltage expressed, characterized, and/or defined in Equation 1. With a matched load resistor (R), the load resistor is equal to, or approximately equal to, a characteristic impedance of a transmission line 114 connecting the electronic component(s) 106 to the transmit antenna(s) 110. The transmission line 114 may be implemented using generally any electrical connector, including one more conductive materials (e.g., wires and/or traces). Having a matched load resistor, the maximum thermal noise power provided by the resistance of the electronic component 106 may be expressed, characterized, calculated, and/or defined using Equation 2, where Equation 2 is shown in FIG. 4. Equation 2 of FIG. 4 shows that the thermal noise power Pₙ depends on, or is a function of, the temperature T and the bandwidth B. For example, a resistor at room temperature (e.g., T=296 Kelvin (K)) with a system bandwidth of 500 megahertz (MHz) (e.g., B=500 MHZ) may have thermal noise power Pₙ of approximately negative 86.9 decibel-milliwatts (dBm) (e.g., Pₙ=−86.9 dBm).

The thermal noise of an electronic component described herein may be white, or approximately white, noise. In some examples, thermal noise is independent, or nearly independent, of frequency within the system's bandwidth. In other aspects, the thermal noise may have a Gaussian distribution. In some examples, a higher system bandwidth may result in a higher thermal noise power Pₙ. In some examples, it may be advantageous for the transmitter 102 to have a well-matched resistor load (e.g., electronic component(s) 106 matched to the antenna 110) to optimize the thermal noise power transfer.

Another form of noise may be excess noise, also known as “1/f” noise. Unlike thermal noise, the excess noise present in a transmitter (e.g., presented by electronic component 106 of FIG. 1) may vary depending on the frequency and the material used to form the resistance of the electronic component. For instance, a carbon composition resistor may produce more excess noise in comparison to a thin film resistor. However, excess noise typically is exhibited at very low frequencies (e.g., at 1 kHz or less). By contrast, the transmitter 102 and/or the system 100 generally operate at frequencies higher than 1 kHz, e.g., higher than where excess noise may be present at particular levels. In some examples, the RF frequency of the wireless communication between the transmitter 102 and the receiver 104 may be 1.4 GHz, in some examples the frequency may be lower than 1.4 GHz (but may be higher than 1 kHz), and in some examples the frequency may be higher than 1.4 GHz. Therefore, the type of the resistor may be less relevant if the system 100 and/or the transmitter 102 is not operating at such low frequencies that excess noise becomes a significant factor.

In some examples, a value of the thermal noise power Pₙ (or an absolute value thereof |Pₙ|) corresponds to a value of a signal intensity, where the signal intensity may be expressed using arbitrary units (a.u.). Therefore, the absolute value of the maximum thermal noise power transmitted by the transmitter 102 may correspond to a maximum value of the signal intensity transmitted by the transmitter 102. On the other hand, the absolute value of the minimum thermal noise power transmitted by the transmitter 102 may correspond to the minimum value of the signal intensity. As described, however, the value of the thermal noise power or the value of the signal intensity changes depending on the impedance matching of the transmission line 114 coupling the electronic component(s) 106 to the transmit antenna(s) 110.

Accordingly, examples of systems and methods described herein may utilize a switch which may have multiple states. Each state of the switch may result in a different impedance presented to an antenna of the transmitter and, accordingly, a different transmitted signal intensity. While examples described herein may generally include two states of the switch, other numbers of states may be used in other examples, including three, four, five, or another number of states.

In some examples, the transmitter 102 may modulate information bits by selectively choosing between impedances presented to the antenna 110. In some examples, the switch may in one state couple the antenna 110 to a resistor load (e.g., the electronic component(s) 106). In another state, the switch may couple the antenna 110 to an open circuit (e.g., disconnect the antenna 110 from the electronic component 106). In such a case, the transmitter 102 may transmit a first value of thermal noise power (e.g., a first value of signal intensity) when the resistor load is electrically connected (e.g., coupled) to the transmit antenna(s) 110, and the transmitter 102 may transmit a second value of thermal noise power (e.g., a second value signal intensity) when the resistor load is electrically disconnected from the transmit antenna(s) 110. In such a case, the absolute value of the first value may be higher than the absolute value of the second value.

As another example, the transmitter 102 may modulate information bits by selectively choosing between a resistor load (e.g., the electronic component(s) 106) and a short circuit to ground connection (e.g., a shunt) to the transmit antenna(s) 110. In such a case, the transmitter 102 may transmit a first value of thermal noise power (e.g., a first value of signal intensity) when the resistor load is electrically connected to the transmit antenna(s) 110, and the transmitter 102 may transmit a second value of thermal noise power (e.g., a second value signal intensity) when the transmit antenna(s) 110 is shorted to ground, where the absolute value of the first value is higher than the absolute value of the second value.

As another example, although not illustrated as such in FIG. 1, the transmitter 102 may modulate information digits by selecting between a first resistor load (e.g., the electronic component(s) 106), a second resistor load (not explicitly illustrated in FIG. 1), and an open circuit connection to the transmit antenna(s) 110. In an example where the characteristic impedance of a transmission line connecting the transmit antenna(s) 110 is 50 Ω, the first resistor (or impedance) load is 50 Ω, the second resistor load is 75 Ω, and the open circuit is considered a theoretical infinite Ω, the transmitter 102 may transmit one of three information bits by selectively choosing between the first resistor load, the second resistor load, and the open circuit. For the sake of clarity, in such a case, the transmitter 102 may transmit a first value of thermal noise power (e.g., a first value of signal intensity) when the first resistor load (e.g., the 50 Ω load) is electrically connected to the transmit antenna(s) 110, and the second resistor load (e.g., the 75 Ω load) is disconnected from the transmit antenna(s) 110. The transmitter 102 may transmit a second value of thermal noise power (or a second value of signal intensity) when the first resistor load (e.g., the 50 Ω load) is electrically disconnected from the transmit antenna(s) 110, and the second resistor load (e.g., the 75 Ω load) is electrically connected to the transmit antenna(s) 110. The transmitter 102 may transmit a third value of thermal noise (e.g., a third value of signal intensity) when the first and the second resistors are electrically disconnected, and the transmit antenna(s) 110 is “connected” to an open circuit load. In such a case, the absolute value of the first value may be higher than the absolute value of the second value, and the absolute value of the second value may be higher than the absolute value of the third value. In some examples, although not illustrated in FIG. 1, the transmitter 102 may modulate information digits by selecting between the first resistor load (e.g., a 50 Ω load), the second resistor load (e.g., a 75 Ω load), and a short circuit (e.g., a 0 Ω load). Therefore, in some examples, each trit of the information trits (e.g., a ternary digit, a trinary digit, or a base 3 digit) may include a first ternary value, a second ternary value, or a third ternary value.

To change the impedance matching, the transmitter 102 utilizes the switch 108. In some examples, the switch 108 may be a radio frequency (RF) switch. In some examples, the switch 108 may be implemented using one or more transistors. In some examples, the switch 108 may be an electro-mechanical switch, a relay, a micro-fabricated (e.g., MEMS) switch, or combinations of any of the described components having resistance(s). In some examples, the switch 108 may be, or may effectively operate as, a single-pole single-throw (SPST) switch (illustrated as SPST switch 116). In some examples, the switch 108 may be, or may effectively operates as, a single-pole double-throw (SPDT) switch (illustrated as SPDT switch 118). In some examples, the switch 108 may be, or may effectively operate as, another switch, where the switch 108 includes more than two states of operation, such as a single-pole triple-throw (SP3T) switch (not explicitly illustrated in FIG. 1). Note that, in FIG. 1, the switch 108 is shown and two optional implementations of the switch are also depicted. In some examples, the switch 108 may be implemented using SPDT switch 118. In some examples, the switch 108 may be implemented using SPST switch 116.

In some examples, the switch 108 may be implemented using an SPST switch 116, and the SPST switch 116 may be coupled between the electronic component(s) 106 and the transmit antenna(s) 110, as is illustrated in FIG. 1. For the sake of clarity, the SPST switch 116 may selectively operate in an open state (or a first state) and a closed state (or a second state). In such a case, the open state of the SPST switch 116 may electrically disconnect the electronic component(s) 106 from the transmit antenna(s) 110. When the SPST switch 116 electrically disconnects the electronic component(s) 106 from the transmit antenna(s) 110, the transmit antenna(s) 110 is terminated with an open circuit terminator or other reference voltage. The open circuit terminator may generally cause an impedance mismatch of the transmission line 114 between the electronic component(s) 106 and the transmit antenna(s) 110. The impedance mismatch causes the transmitter 102 to transmit a lower absolute value of the thermal noise power Pₙ or a lower value of the signal intensity compared to a threshold absolute value of the thermal noise power Pₙ or a threshold value of the signal intensity. On the other hand, the closed state of the SPST switch 116 electrically connects the electronic component(s) 106 to the transmit antenna(s) 110, which generally increases the impedance matching between the electronic component(s) 106 and the characteristic impedance of the transmission line 114 connecting the electronic component(s) 106 to the transmit antenna(s) 110. The increased impedance matching, or in some cases, the matched impedance, causes the transmitter 102 to transmit a higher (including a maximum) absolute value of the thermal noise power Pₙ or a higher (including a maximum) value of the signal intensity compared to the threshold absolute value of the thermal noise power Pₙ or the threshold value of the signal intensity.

In some examples, the switch 108 may be implemented using the SPST switch 116. However, although not illustrated as such in FIG. 1, the electronic component(s) 106 may be coupled directly to the transmit antenna(s) 110. In such a case, a first terminal of the SPST switch 116 may be coupled to the electronic component(s) 106, the transmission line 114 between the electronic component(s) 106 and the transmit antenna(s) 110, and/or the transmit antenna(s) 110. A second terminal of the SPST switch 116 may be coupled to a reference voltage 128 node (e.g., at a ground level) via a connector 126, where the connector 126 and the reference voltage 128 operate as a shunt. In such a configuration, the open state of the SPST switch 116 allows the electronic component(s) 106 to be electrically connected to the transmit antenna(s) 110 and/or the transmission line 114 between the electronic component(s) 106 and the transmit antenna(s) 110. Since the impedance of the electronic component(s) 106 is somewhat matched, approximately matched, or matched to the characteristic impedance of the transmission line 114 connecting the electronic component(s) 106 to the transmit antenna(s) 110, the transmitter 102 transmits a higher absolute value of the thermal noise power Pₙ or a higher value of the signal intensity compared to the threshold absolute value of the thermal noise power Pₙ or the threshold value of the signal intensity. On the other hand, the closed state of the SPST switch 116 shorts (or shunts) the transmit antenna(s) 110 to reference voltage 128. Therefore, the closed state of the SPST switch 116 causes an impedance mismatch between the short (i.e., 0 Ω) and the characteristic impedance (e.g., 50 Ω) of the transmission line 114 connected to the transmit antenna(s) 110. Consequently, the transmitter 102 transmits a lower absolute value of the thermal noise power Pₙ or a lower value of the signal intensity compared to the threshold absolute value of the thermal noise power Pₙ or the threshold value of the signal intensity.

In some examples, the switch 108 may be implemented using an SPDT switch 118, and the SPDT switch 118 may be coupled between the electronic component(s) 106 and the transmit antenna(s) 110, as is illustrated in FIG. 1. For the sake of clarity, the SPDT switch 118 may selectively operate in a first state (e.g., a first throw of the SPDT switch 118) or in a second state (e.g., a second throw of the SPDT switch 118). In such a case, the first state of the SPDT switch 118 may electrically connect the electronic component(s) 106 to the transmit antenna(s) 110. When the SPDT switch 118 electrically connects the electronic component(s) 106 to the transmit antenna(s) 110, the transmit antenna(s) 110 transmits a higher absolute value of the thermal noise power Pₙ or a higher value of the signal intensity compared to a threshold absolute value of the thermal noise power Pₙ or a threshold value of the signal intensity. On the other hand, the second state of the SPDT switch 118 may create an electrical short (e.g., a shunt) by electrically connecting the transmit antenna(s) 110 to the connector 126, where the connector 126 is connected to reference voltage 128 or another reference voltage.

Regardless of the design and/or the technology used to implement the switch 108, the switch 108 may selectively change the impedance matching of the transmitter 102, and/or to selectively change the impedance matching between the electronic component(s) 106 and the transmission line 114 connecting the electronic component(s) 106 to the transmit antenna(s) 110. In this manner, the transmitter 102 may transmit different thermal noise powers or signal intensities by selecting between the connection between an electronic component(s) 106 and an open and/or a short or other resistance. Therefore, the transmitter 102 may modulate information bits by switching between the electronic component(s) 106 (e.g., 50 Ω) and an open (e.g., ∞Ω) or a short (e.g., 0 Ω), or another resistance, where each bit of the information bits may include a first binary value or a second binary value. Generally, the transmitter 102 may modulate information bits by presenting a first impedance to the antenna 110 or a second impedance to the antenna 110, where the first impedance is a closer impedance match to the antenna 110 compared to the second impedance.

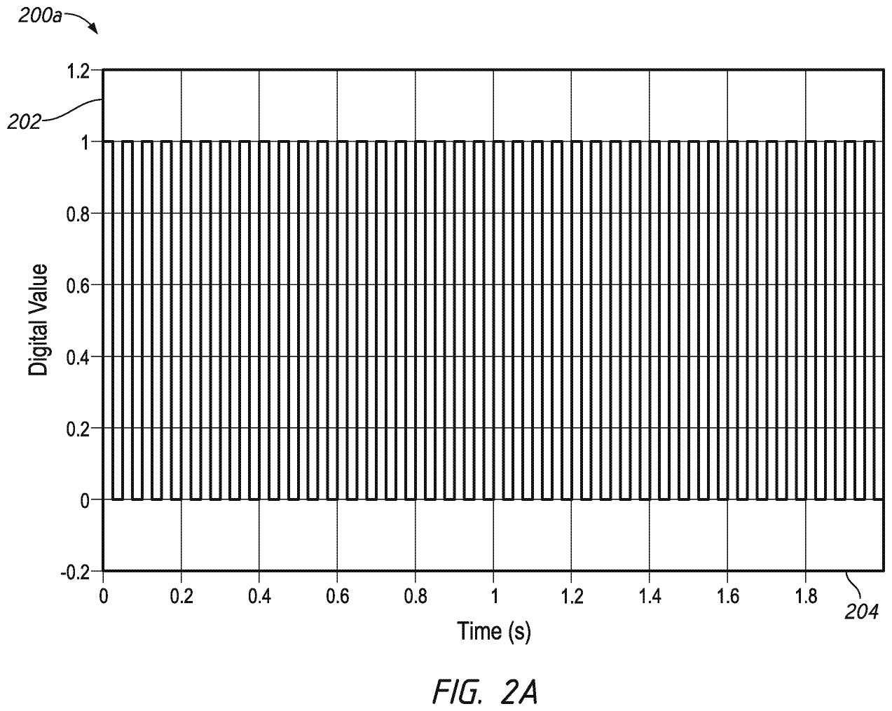

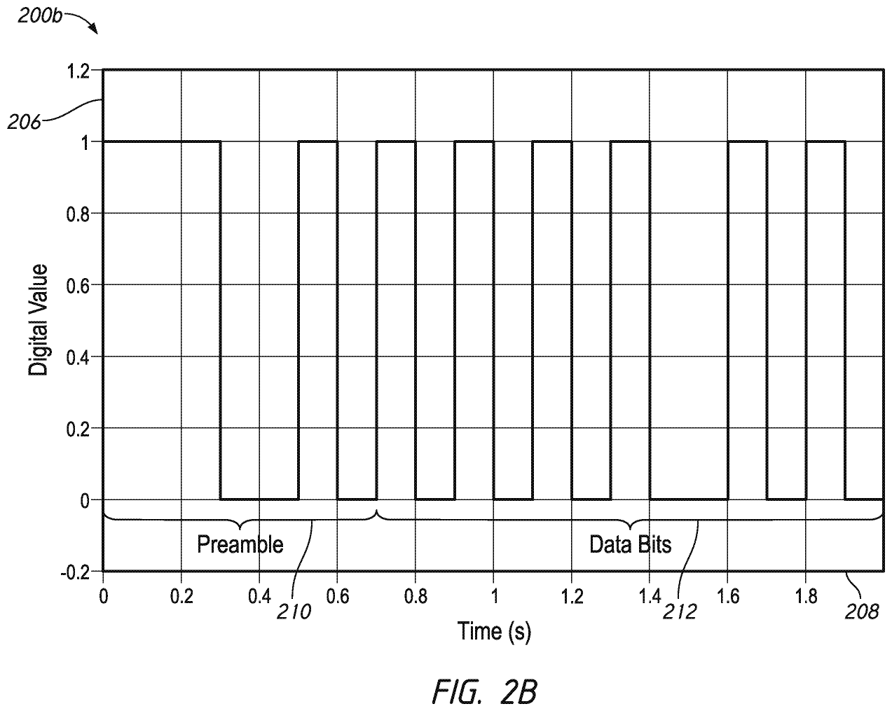

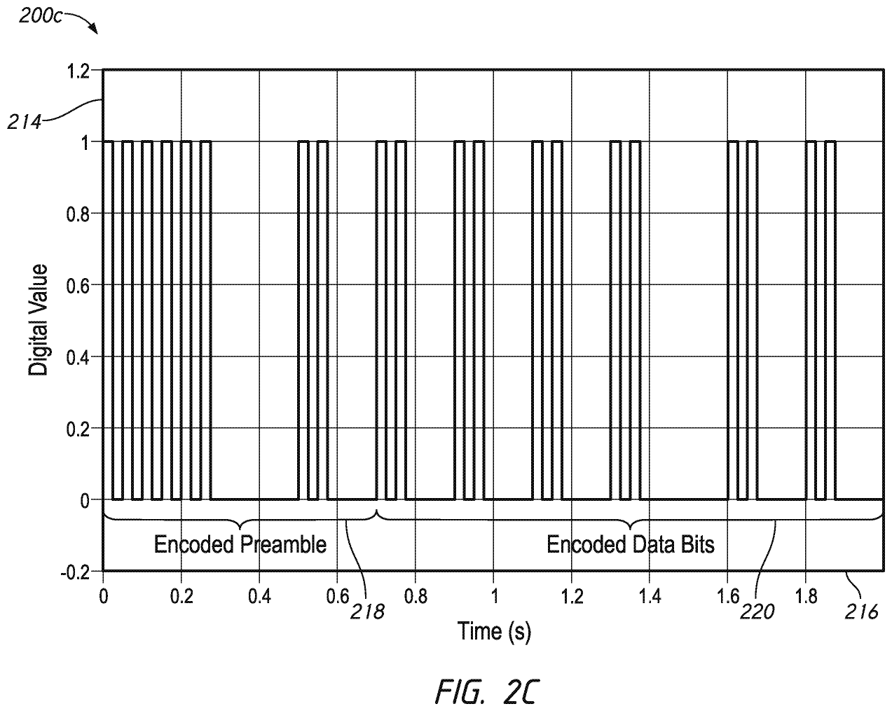

Digital logic, such as controller 112 of FIG. 1, may be used to control an impedance provided to a transmitter antenna described herein. For example, the controller 112 may control switch 108. The impedance presented to the antenna may be controlled in accordance with data intended for transmission. In some examples, the controller 112 may be implemented using circuitry, microcontroller(s), and/or processor(s). The controller 112 may include a subcarrier generator 120 to generate a subcarrier frequency, such as a square-wave subcarrier frequency (e.g., see FIG. 2A). In some examples, the subcarrier generator 120 may be a microcontroller, which may be clocked via, for example, a crystal-based oscillator circuit (not explicitly illustrated). Nevertheless, a variety of oscillators may be used to generate a subcarrier frequency, such as ceramic resonators, ring oscillators, RC oscillators, LC oscillators, relaxation oscillators, voltage-controlled oscillators, GNSS-disciplined (e.g., GPS-disciplined) oscillators, or other oscillators that may generate a subcarrier frequency.

In some examples, the transmitter 102 and the receiver 104 operate using the same, or approximately the same, oscillation subcarrier frequency. The subcarrier frequency may be in the order of 100 Hz, or some other relatively low frequency. Therefore, the subcarrier frequency is considerably lower than the RF frequency of the wireless communication between the transmitter 102 and the receiver 104, where the RF frequency may be 1.4 GHz, lower than 1.4 GHz, or higher than 1.4 GHz. A lower subcarrier frequency may save power and/or energy, whereas a higher subcarrier frequency may provide a better performance, while using more power and/or energy. For example, a manufacturer of the transmitter 102 and the receiver 104 may select to use the lowest subcarrier frequency that allows the wireless communication between the transmitter 102 and the receiver 104 to have a threshold bit error rate (BER) determined by the manufacturer. In some examples, a phase agreement between an oscillator (not illustrated) of the subcarrier generator 120 of the transmitter 102 and an oscillator (not illustrated) of the receiver 104 may not be used, because the receiver 104 may perform in-phase (I) and quadrature (Q) demodulation of a received signal, and the receiver 104 may compute the magnitude of the received signal using the processor 138, as is further described.

In some examples, even though the transmitter 102 may be power constrained, the receiver 104 may not have the same stringent power constraints. In such a case, the transmitter 102 may utilize a less accurate oscillator that uses less power, and the receiver 104 may perform a search over a range of oscillator frequencies to find and/or determine the subcarrier frequency used by the transmitter 102.

In some examples, the controller 112 may provide a control signal 130, which is provided to (e.g., selectively controls) the switch 108. For example, the control signal 130 may control the switch 108 to place the switch 108 in an open state or a closed state, such as when the switch 108 is implemented as the SPST switch 116. As another example, the control signal 130 may control the switch 108 to place the switch 108 in a first state or a second state, such as when the switch 108 is implemented as the SPDT switch 118.

In some examples, to transmit a digital (e.g., a binary) level or value (e.g., a “0”), the control signal 130 controls the switch 108 to remain in a static state, such as to remain as an open circuit, with the transmit antenna(s) 110 disconnected from the electronic component(s) 106. To transmit another digital level (e.g., a “1”), the control signal 130 controls the switch 108 to switch between the states. For example, the switch 108 may switch between an open state and a closed state at the subcarrier frequency (e.g., at the square-wave subcarrier frequency of FIG. 2A), disconnecting and connecting the transmit antenna(s) 110 from the electronic component(s) 106.

The transmitter 102 may transmit data 122, where the data 122 may generally be representative of any information. For example, the data 122 may be a temperature sensor measurement(s) obtained from a temperature sensor(s); a motion sensor measurement(s) obtained from a motion sensor(s); a text message sent by a person; a pressure sensor value(s) obtained from a pressure sensor(s); a light level value(s) or lux obtained from a light sensor(s); accelerometer values; pixel values from a camera; audio or vibration information; and/or an identification string, such as information that may be provided by an RFID tag. Other data may be used in other examples. It is to be understood, however, that the transmitter 102 may be less complex and/or may consume less power than a conventional RFID tag. For example, the conventional RFID tag requires generation of a carrier and may need to account for self-interference. By contrast, the transmitter 102 transmits digital information without using and/or generating a carrier, without relying on pre-existing RF signals, and/or does not generate self-interference.

Moreover, the data 122 may be communicated directly from the sensor(s) to the controller 112, or the data 122 may be stored in a computer-readable medium (not illustrated). In some examples, the computer-readable medium may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth.

Examples of systems described herein may include a receiver. The receiver may be used to receive (e.g., decode) transmissions sent by transmitters described herein, to recover data. Receiver 104 is shown in FIG. 1. In some examples, the receiver 104 includes a receive antenna(s) 132, at least one low noise amplifier (illustrated as “low noise amplifier 134”), a power level detector 136, and a processor 138. In some examples, the receive antenna(s) 132 and the transmit antenna(s) 110 may be the same or may be different. In some examples, the receive antenna(s) 132 may be an antenna with a higher gain compared to the transmit antenna(s) 110. In some examples, the receive antenna(s) 132 and/or the transmit antenna(s) 110 may include one or more antennae. In some examples, the receive antenna(s) 132 and/or the transmit antenna(s) 110 may be pyramidal horn antennae, coil antennae, antennae printed on (or embedded in) a printed circuit board (PCB), or another type of antennae. The composition, material, design, and/or size of the transmit antenna (e 110 and/or the receive antennae 132 may vary. For example, the system 100 may be, or may be utilized by, a medical device (e.g., an implanted medical device). Accordingly, the transmitter 102 may transmit low-powered signals which may reduce and/or eliminate tissue damage caused by transmissions and/or reduce and/or eliminate interference with other medical devices. In some examples, coil antennae may be used. Coil antennae may generally transit a measurable magnetic field that propagates well (or with ease) through tissue.

In some examples, the receive antenna(s) 132 is coupled to the low noise amplifier 134. The low noise amplifier 134 may amplify a low-power signal being received by the receive antenna(s) 132, while maintaining a good signal-to-noise ratio (SNR). In some examples, in addition to the low noise amplifier 134, the receiver 104 may also include a bandpass filter (not illustrated) and another low noise amplifier (not illustrated), where the bandpass filter may be coupled between the low noise amplifier 134 and the other low noise amplifier. Generally, the two low noise amplifiers may be implemented using two high-gain low noise amplifiers. If the receiver 104 utilizes the bandpass filter, the bandpass filter may prevent and/or reduce feedback oscillation and/or reduce the effect of interfering signals. Feedback oscillation may occur, for example, when strong amplified signals from the output of a low noise amplifier couple back to the input, resulting in unwanted oscillations, which are false and/or undesirable signals. The bandwidth of the bandpass filter may be selected by a designer, such that advantageously neither of the low noise amplifiers saturate (e.g., reaching their maximum voltage). A larger bandwidth filter leads to larger received power, which is generally desirable.

In some examples, if the receiver 104 uses only the low noise amplifier 134, the power level detector 136 is coupled to the low noise amplifier 134. In some examples, if the receiver 104 also includes a bandpass filter (not illustrated) and a second low noise amplifier (not illustrated), the power level detector 136 is coupled to the second low noise amplifier. The power level detector 136 may be implemented using hardware, software, firmware, or a combination thereof. For example, the power level detector 136 may include RF hardware, such as a diode rectifier, an envelope follower, an amplifier, an analog-to-digital converter (ADC), a tuner (e.g., a multiplier), a low pass filter, or a combination thereof that are capable of measuring signal power or strength, such as the thermal noise power Pₙ. As another example, the power level detector 136 may be or may include a software defined radio. The software defined radio (e.g., the power level detector 136) may be coupled to the low noise amplifier 134 (or the second low noise amplifier) and may be provided with amplified signals received by the low noise amplifier. In some examples, the software defined radio converts the received RF signal down to a baseband signal. The software defined radio may then digitize the baseband signal. The baseband signal of the software defined radio may then be processed by the processor 138 to recover data transmitted by one or more transmitters described herein.

In some examples, the processor 138 is coupled to the power level detector 136, and the processor 138 may be substantially any electronic device that may be capable of processing, receiving, and/or transmitting signals and/or instructions (e.g., code). In aspects, the processor 138 may be implemented using one or more of a central processing unit (CPU), a graphic processing unit (GPU), a microcontroller unit (MCU), an application specific integrated circuit (ASIC), a field programmable gate array (FPGA), a microprocessor, a microcomputer, and/or other circuitry. The processor 138 may receive signals from the power level detector 136 and extract data packets from the received signals.

FIG. 2A is a graph of a square-wave subcarrier arranged in accordance with examples described herein. The graph 200a has a y-axis of digital value 202 and an x-axis of time 204. The graph 200a illustrates a square-wave subcarrier signal having a subcarrier frequency. The square-wave subcarrier shown in FIG. 2A may be generated by one or more subcarrier generators described herein, such as the subcarrier generator 120 of FIG. 1.

The subcarrier signal shown in FIG. 2A is exemplary only and other subcarrier signals may be used in other examples-including signals having other frequencies and/or shapes.

FIG. 2B is a graph of data to be transmitted in accordance with examples described herein. The data shown in FIG. 2B is digital (e.g., having a value of 1 or 0). The data shown in FIG. 2B is shown in a graph 200b having a y-axis 206 representing the digital value and an x-axis 208 representing time. The data is shown having a packet format, including data in a preamble 210 and a payload including data bits 212.

The data shown in FIG. 2B may be used to implement data for transmission described herein, such as the data provided to the controller 112 of FIG. 1. The data shown in FIG. 2B may be decoded by receivers described herein, such as receiver 104 of FIG. 1.

The data shown in FIG. 2B is exemplary only. Other data may be used in other examples, including generally any amount or rate of data. The data may or may not be packetized in various examples.

FIG. 2C is a graph of a control signal used to control one or more switches described herein. Note that the graph of FIG. 2C also represents a transmitted signal encoding data arranged in accordance with examples described herein. The graph 200c of FIG. 2C generally depicts the encoding of the data of FIG. 2B using the subcarrier of FIG. 2A. The graph 200c includes an x-axis 214 of digital value, and a y-axis 216 of time. The control signal or encoded signal depicted in FIG. 2C accordingly has a preamble 218 and payload representing data bits 220.

The control signal of FIG. 2C may be used to implement control signals for switches described herein, such as the control signal 130 of FIG. 1. The control signal may generally control a switch to remain static in a particular state (e.g., open) during a data bit having a particular value (e.g., 1), or to switch between two states (e.g., open and closed), during a data bit having another value (e.g., 0). Accordingly, in the transmitted signal, a constant portion of the signal may represent one digital value of data while a switching signal at the subcarrier frequencies may represent another digital value.

The control signal shown in FIG. 2C is exemplary only. Other control signals may be used in other examples, and the particular data value represented by a constant portion of signal versus the data value represented by a switching portion may be flexible (e.g., 1 and 0 respectively in some examples, 0 and 1 in some examples).

FIG. 2A, FIG. 2B, and FIG. 2C are illustrated and described in the context of FIG. 1. It is to be understood, however, that the example values illustrated in FIG. 2A, FIG. 2B, and FIG. 2C are non-limiting example values. For example, the graph 200a is a function of a digital value 202 axis (e.g., a “0” or a “1”) versus a time 204 axis; thereby, the graph 200a illustrates an example square-wave subcarrier frequency. Other subcarrier frequencies, however, may be used for modulation of the data packet. As another example, the graph 200b shows the data packet as a function of a digital value versus a time. The data packet includes a preamble 210 followed by data bits 212, where the data bits 212 of FIG. 2B may represent the data 122 of FIG. 1 or a data payload. The preamble 210 may be used to encode the data bits 212 (or the data 122 of FIG. 1). In the example graph 200b, the preamble 210 includes a 7-bit Barker code. Another type of code, however, may be used to implement the preamble 210. The graph 200c shows the encoded data packet as a function of a digital value versus a time, where the encoded data packet includes an encoded preamble 218 and an encoded data bits 220. For the sake of clarity, the values of the time 204, the time 208, and the time 216 axes of FIG. 2A, FIG. 2B, and FIG. 2C, respectively, are the same and/or are illustrated using the same time scale.

In some examples, the transmitter 102 of FIG. 1 uses examples of the described thermal noise techniques to transmit the data 122 of FIG. 1. For example, using the transmitter 102, the data 122 of FIG. 1 and/or the data packet of FIG. 2B (including the preamble 210 and the data bits 212) may be modulated using an ON-OFF keying approach. When using the ON-OFF keying approach, the transmitter 102 may transmit a 0-bit using the control signal 130 of FIG. 1 to selectively cause the switch 108 to stay in the OFF state. For example, when implementing the switch 108 using the SPST switch 116, the SPST switch 116 stays open, and the electronic component(s) 106 is electrically disconnected from the transmit antenna(s) 110. Alternatively, the transmitter 102 may transmit a 1-bit by selectively switching the switch 108 (e.g., the SPST switch 116) between both the ON and the OFF states (e.g., between an open circuit terminated, and an electronic component(s) 106 or a resistor terminated) at a subcarrier frequency, such as the square-wave subcarrier frequency illustrated in FIG. 2A. Accordingly, the subcarrier frequency may correspond with the switching speed of the switch 108.

The example graph 200c illustrates the controller 112 of transmitter 102 combining (e.g., multiplying) the subcarrier shown in the graph 200a with a “1” or a “0” depending on the values (e.g., digits, bits) of the data packet of the graph 200b. Therefore, the example graph 200c illustrates a control signal which may be used to transmit data using modulation of thermal noise using an ON-OFF keying approach. Alternatively, the transmitter 102 may multiply the square-wave subcarrier frequency with a “+1” or a “−1” depending on the values of the data packet. In this alternative approach (not illustrated in graph 200b and/or graph 200c), the transmitter 102 (e.g., controller 112) may modulate thermal noise using a binary phase shift keying (BPSK) approach (e.g., a BPSK encoding). Accordingly, the controller 112 may include a modulator which may utilize ON-OFF keying and/or BPSK modulation. Other modulation techniques may be used in other examples to combine a subcarrier with data.

In some examples, when the transmitter 102 transmits a higher signal intensity, there is an impedance presented to the transmit antenna(s) 110 that is more matched than when the transmitter 102 transmits a lower signal intensity. The magnitude of the thermal noise power transmitted during the higher signal intensity is higher than the magnitude of the thermal noise power during the lower signal intensity (or vice versa in other examples). The transmitted thermal noise power depends on the thermal noise that may be generated by the electronic component 106.

The transmitted signal may be expressed, characterized, calculated, and/or defined using Equation 3, where Equation 3 is shown in FIG. 4. In Equation 3 of FIG. 4, sᵣₓ denotes an encoded signal that is transmitted by the transmitter 102 and to be received by the receiver 104; m denotes a bit to be encoded, and m may have a value of, for example, “0” or “1”; sgn denotes the sign (or the signum function), and sgn may have a value of, for example, “+1” or “−1”; sin denotes the trigonometric sine function; f_{sc} denotes the subcarrier frequency; and t denotes time.

In some examples, the system 100 of FIG. 1 is implemented in such a way that the subcarrier frequency f_{sc} is known by the receiver 104 of FIG. 1 (for example, the subcarrier frequency may be stored in one or more memory devices of the receiver 104). Therefore, the transmitter 102 and the receiver 104 of the system 100 utilize the same subcarrier frequency f_{sc}, for example, the square-wave subcarrier frequency of FIG. 2A. By so doing, the receiver 104 may demodulate the received signal by performing a heterodyne detection. Using the heterodyne detection allows the receiver 104 (or the system 100) to reject noise by filtering out any received signal power that is outside the relatively narrow bandwidth of the subcarrier frequency.

In some examples, the receiver 104 may generate a receive-side subcarrier frequency with amplitude values of “+1” and “−1,” where the receive-side subcarrier frequency is the same subcarrier signal or frequency used in the transmitter 102. The receiver 104 may then multiply the received signal with the receive-side subcarrier frequency, and the receiver 104 may accumulate (e.g., integrate) the product values for a duration that is less than or equal to the duration of one bit (or one digit). This process results in a demodulated signal intensity, which may be expressed, characterized, and/or defined using Equation 4 of FIG. 4, where T denotes the total integration time.

In some examples, the receiver 104 compares the demodulated signal intensity to a threshold signal intensity value, and the receiver 104 determines whether a 1-bit or a 0-bit was transmitted by the transmitter 102. As described, the data packet includes a preamble (e.g., preamble 210) followed by a data payload (e.g., the data bits 212). The receiver 104 performs a cross-correlation, using the processor 138 of FIG. 1, to detect the preamble 210. The processor 138 may then extract the data bits 212. For example, the receiver may detect a difference between a constant signal and one that is alternating between a high and low. The constant signal may be decoded as one level of bit (e.g., a 0) and the alternating signal may be decoded as another level of bit (e.g., a 1).

In addition to, or alternatively of, performing heterodyne detection using in-phase subcarrier signals, the same, or an equivalent, process may be performed using subcarrier signals that are 90 degrees out of phase. To do so, measured values for both in-phase (I) and quadrature (Q) components of the received signals are provided to the receiver 104. Using the I and Q values, the processor 138 of the receiver 104 may compute the magnitude (e.g., \sqrt{I²+Q²}) of the received signals to minimize the phase offset between the transmitter 102 and the receiver 104.

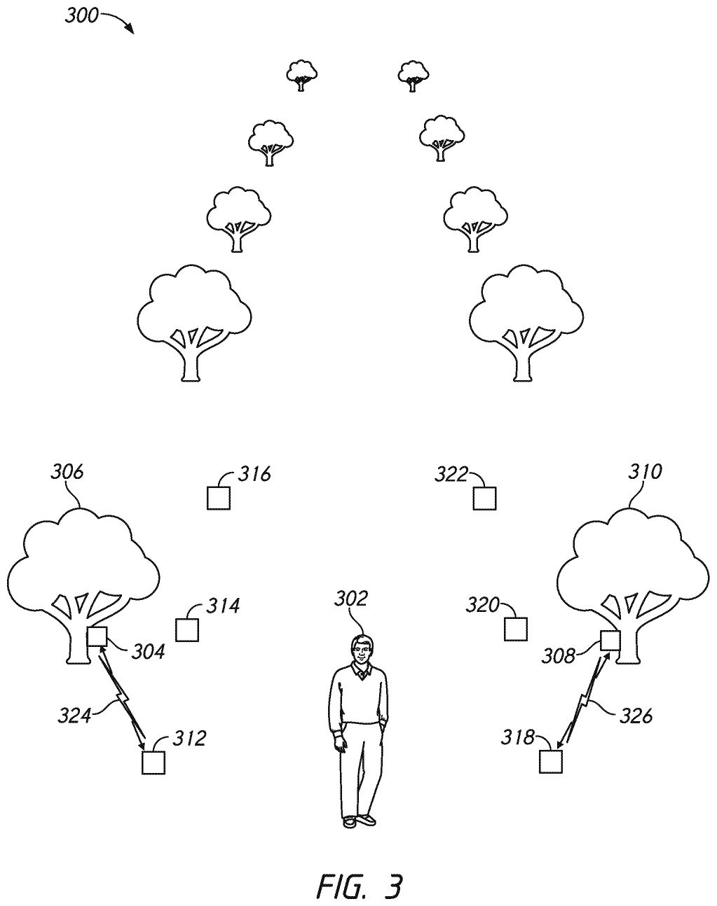

FIG. 3 is a schematic illustration of an example of a system deployed in an environment to perform a precision agriculture application in accordance with examples described herein. FIG. 3 depicts an example of an environment 300 which may include an orchard. A user 302 is shown. Transmitters 312, 314, 316, 318, 320, and 322 are shown disposed about the environment. Receivers 304 and 308 are also disposed in the environment. The orchard of FIG. 3 includes trees, such as tree 306 and tree 310. The transmitters may communicate with the receivers as indicated by wireless communication 324 and wireless communication 326 in FIG. 3.

The components of FIG. 3 are exemplary. Additional, fewer, and/or different components may be used in other examples. For example, any number of transmitters and receivers may be disposed about the environment. Data collected by the receivers may be communicated to one or more other computing systems for storage, manipulation and/or display. The data may be used, for example, to determine any of a variety of actions regarding the environment, including the application of fertilizer, and amount or frequency of irrigation, or other actions.

The transmitters and receivers of FIG. 3 may be implemented by and/or used to implement the transmitter and receiver of FIG. 1. For example, any or all of transmitters 312, 314, 316, 318, 320, and/or 322 may be implemented using transmitter 102 of FIG. 1. Any or all of receivers 304 or 308 may be implemented using receiver 104 of FIG. 1. The transmitters and receivers of FIG. 3 may communicate with each other using the communication techniques described herein, including use of the control signals shown and described with reference to FIG. 2A, FIG. 2B, and FIG. 2C.

FIG. 3 illustrates a user 302 tending to their orchard. While described as a farmer, generally any user may take the actions described with reference to user 302. The orchard may be in a remote area, away from TV towers, radio towers, or other ambient backscatter generators. Fortunately, the user 302 may utilize one or more transmitters, one or more receivers, and/or one or more systems 100 of FIG. 1 to help detect, read, measure, and/or monitor information regarding soil conditions, ambient and/or weather conditions, sunlight, and/or other information. Information regarding the soil conditions may include pH readings, moisture readings, fertilizer readings (e.g., an amount of nitrogen (N), an amount of phosphorus (P), an amount of potassium (K), an amount of phosphate (P₂O₅), or an amount of potash (K₂O)), and/or other substances and/or concentration(s) of the substances.

In some examples, the user 302 may install a first receiver 304 on a first tree 306, a second receiver 308 on a second tree 310, and/or other receivers (not explicitly illustrated in FIG. 3) on other trees. While described as placed on trees, the receivers may be disposed anywhere in the environment and positioned to receive communications from one or more transmitters. The user 302 has also installed a plurality of transmitters that may communicate wirelessly with the respective receivers 304 and 308. The plurality of transmitters may increase the monitored area of the orchard. For example, the user 302 may install (e.g., on the orchard floor) a first transmitter 312, a second transmitter 314, a third transmitter 316, and/or another or other transmitter(s) near the receiver 104. As another example, the user 302 may install a fourth transmitter 318, a fifth transmitter 320, a sixth transmitter 322, and/or another or other transmitter(s) near the second receiver 308. The transmitters and/or the receivers of FIG. 3 may be implemented using the transmitter 102 and/or the receiver 104 of FIG. 1. The transmitters (e.g., the transmitters 312 to 322) of FIG. 3 generally may transmit data (e.g., data received from one or more soil sensors coupled to the transmitter) by modulating thermal noise of an electronic component of the transmitter.

In some examples, each of the transmitters (e.g., the transmitters 312 to 322 of FIG. 3) is equipped with, is connected to, and/or may communicate with, one or more sensors that may detect, read, measure, and/or monitor information regarding the soil conditions, the ambient and/or weather conditions, sunlight, and/or other information. The sensor(s) (not explicitly illustrated in FIG. 3) may be a light sensor, a moisture sensor, a pH sensor, a nitrogen (N), phosphorus (P), and potassium (K) sensor (e.g., an NPK sensor), and/or another sensor that may detect, read, measure, and/or monitor information regarding the soil conditions, the ambient and/or weather conditions, sunlight, and/or other information.

In some examples, the sensor(s) provides data to the controller of a respective transmitter. The transmitter may perform data encoding and modulation, where the data may include a respective preamble and a respective data bits. For example, an associated sensor of the transmitter 312 may detect, read, measure, and/or monitor information regarding the soil conditions, the ambient and/or weather conditions, sunlight, and/or other information. Sensor data may accordingly be provided to the controller of the first transmitter 312. The first transmitter 312 may transmit the data packet to the first receiver 304 using a first wireless communication 324. The wireless communication 324 may utilize modulation of thermal noise of one or more components of the transmitter 312. As another example, an associated sensor of the transmitter 318 may detect, read, measure, and/or monitor information regarding the soil conditions, the ambient and/or weather conditions, sunlight, and/or other information. The transmitter 318 may transmit the data packet to the second receiver 308 using a second wireless communication 326. FIG. 3 does not illustrate all the wireless communications which may be occurring in the environment 300.

In some examples, the respective receivers (e.g., the first receiver 304, the second receiver 308) receive the data packets, which may be encoded data packets. The receivers may perform data packet detection and demodulation. In some examples, each encoded data packet may include a unique encoded preamble that is associated with a unique transmitter. Accordingly, each receiver may decipher which transmitter transmitted the encoded data packet. In some examples, some or all the transmitters may use the same encoded preamble. Accordingly, each receiver may decipher whether the data packet is transmitted by the transmitters, as supposed to being transmitted by another source, such as another unidentified and/or unrelated source that is not part of the system. After a receiver verifies an encoded preamble of the encoded data packet, the receiver may extract the encoded data bits, where the encoded data bits may represent the data (e.g., the sensor data).

The data decoded by the receivers of the system of FIG. 3 may be stored and/or transmitted to one or more other computing systems. By receiving data from sensors disposed about the environment, a user 302 (such as a farmer) may obtain information about soil or other orchard conditions. Due to the low-power nature of the data transmissions, the transmitters may be able to function for a long time in the environment without a need for a wired power source or a battery change. The transmitters may be powered by one or more batteries and/or energy harvesting techniques where energy may be harvested from the environment (e.g., thermal, wind, solar, geothermal, or other energy harvesting techniques).

In some examples, each receiver of FIG. 3 may be part of, or maybe embedded in, a recording device (not illustrated). In such a case, the receivers of FIG. 3 and the recording devices may not have the same power constraints of the transmitters of FIG. 3. In some examples, each of the recording devices may include memory and an interface. The interface, for example, a universal serial bus (USB) interface, allows the user 302 to download data transmitted by the transmitters of FIG. 3. To do so, the user 302 may plug in a flash drive to download any data saved on the respective memories of the recording devices. The user 302 may then analyze the data using a user device (e.g., a device located in their home or office). In some examples, each of the recording devices may include memory and a display screen. The display screen of the recording device may display the data transmitted by the transmitters of FIG. 3 and received by the receivers of FIG. 3.

In some examples, each receiver of FIG. 3 may be part of, or maybe embedded in, a communication device (not illustrated). Depending on the type of the communication device, communication(s) in the environment 300 of FIG. 3 may be performed using various protocols and/or standards. Examples of such protocols and standards include: an Institute of Electrical and Electronics (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and/or standards that may be established and/or maintained by various governmental, industry, and/or academia consortiums, organizations, and/or agencies; and so forth. For example, the communication devices equipped with the receivers of FIG. 3 may be part of a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS)).

Therefore, in addition to the communications illustrated in FIG. 3, the environment 300 may facilitate other unidirectional, bidirectional, wired, wireless, direct, and/or indirect communications utilizing one or more communication protocols and/or standards. Therefore, FIG. 3 does not necessarily illustrate all communication signals.

Regardless of the type of device that utilizes the receivers of FIG. 3, the user 302 may retrieve the data transmitted by the transmitters of FIG. 3 to the receivers of FIG. 3. By so doing, the user 302 may make informed decisions regarding the amount of water, fertilizer, and/or other factors to increase yield, preserve resources, and/or be a good steward of the land and/or soil of the orchard.

Accordingly, systems described herein may find use in a variety of applications including precision agriculture, internet of things (IoT) devices, and/or implanted or wearable medical devices. Systems may find use in agriculture, horticulture, monitoring natural resources, monitoring ambient conditions, monitoring wildlife, monitoring livestock, monitoring medical conditions, monitoring vital signs, and/or other applications that may benefit from wireless passive communication without relying on pre-existing RF signals and/or without using a carrier signal. Examples of the disclosed systems, apparatuses, and methods perform passive wireless communication, while reducing power consumption and/or conserving power compared to other, or conventional, solutions. The disclosed systems, apparatuses, and methods may be used in economically-developed countries and/or in economically-developing countries.

FIG. 4 shows a list 400 of equations, having a first equation (“Equation 1”), a second equation (“Equation 2”), a third equation (“Equation 3”), and a fourth equation (“Equation 4”), where the list 400 of equations is referred to at the appropriate portions of the text herein.

As described, in some examples, thermal noise of, for example, an electrical conductor, an electrical circuit, and/or an electronic component may be expressed, characterized, calculated, and/or defined using Equation 1 of FIG. 4. In Equation 1, Vₙ² denotes the mean-squared voltage of thermal noise; k denotes the Boltzmann's constant; T denotes the temperature; B denotes the bandwidth; and Re (Z) denotes the real part (i.e., Re) of the impedance (i.e., Z) of the example electrical conductor, electrical circuit, and/or electrical component.

As described, in some examples, a resistor (R) with thermal noise may be modeled as a Thevenin equivalent circuit that includes a noiseless resistor and a noise voltage generator with a voltage expressed, characterized, and/or defined in Equation 1 of FIG. 4. With a matched load resistor (R), the load resistor is equal to, or approximately equal to, a characteristic impedance of a transmission line 114 of FIG. 1 connecting the electronic component(s) 106 of FIG. 1 to the transmit antenna(s) 110 of FIG. 1. Having a matched load resistor, the maximum thermal noise power provided by the noise resistor may be expressed, characterized, calculated, and/or defined using Equation 2 of FIG. 4. Moreover, Equation 2 of FIG. 4 shows that the thermal noise power Pₙ depends on, or is a function of, the temperature T and the bandwidth B.

As described, in some examples, a transmitted signal, using the transmitter 102 of FIG. 1, may be expressed, characterized, calculated, and/or defined using Equation 3 of FIG. 4. In Equation 3, sᵣₓ denotes an encoded signal that is transmitted by the transmitter 102 of FIG. 1 and to be received by the receiver 104 of FIG. 1; m denotes a bit to be encoded, and m may have a value of, for example, “0” or “1”; sgn denotes the sign (or the signum function), and sgn may have a value of, for example, “+1” or “−1”; sin denotes the trigonometric sine function; f_{sc} denotes the subcarrier frequency; and t denotes time.

As described, in some examples, the receiver 104 of FIG. 1 may generate a receive-side subcarrier frequency with amplitude values of “+1” and “−1,” where the receive-side subcarrier frequency is the same subcarrier signal or frequency used in the transmitter 102 of FIG. 1. The receiver 104 of FIG. 1 may then multiply the received signal with the receive-side subcarrier frequency, and the receiver 104 may accumulate (e.g., integrate) the product values for a duration that is less than or equal to the duration of one bit (or one digit). This process results in a demodulated signal intensity, which may be expressed, characterized, and/or defined using Equation 4 of FIG. 4, where T denotes the total integration time.

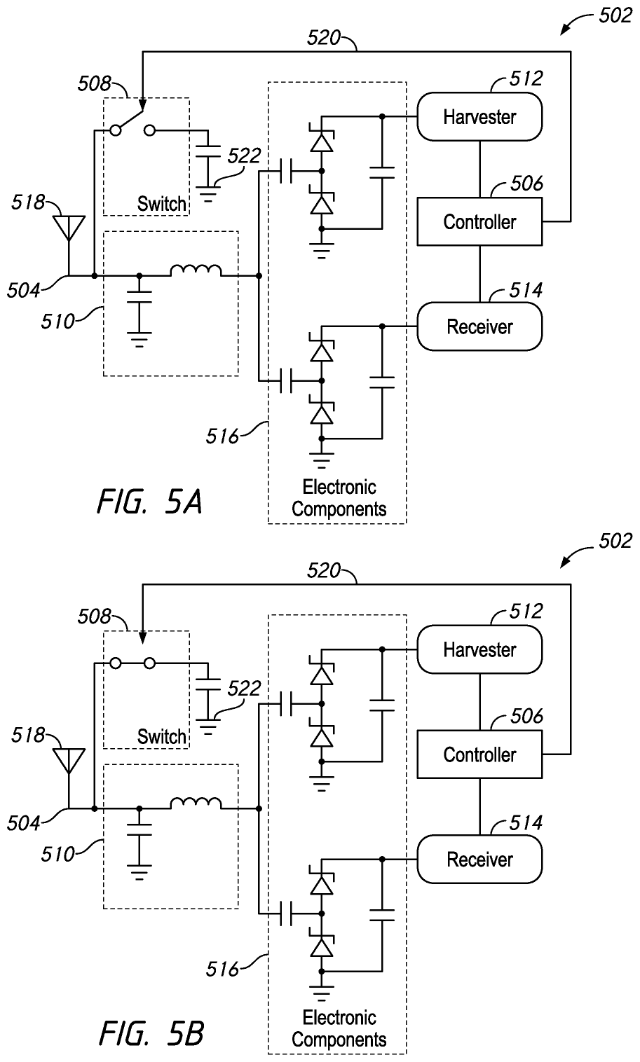

FIGS. 5A and 5B are schematic diagrams of a transmitter 502, in accordance with examples described herein. In some examples, the transmitter 502 may be implemented on an RFID tag.

In some examples, the transmitter 502 may include an antenna 518 attached to an output node 504, a controller 506, a switch 508 coupled to the output node 504, an impedance matching network 510 coupled to the output node 504 and one or more electronic components 516. The one or more electronic components 516 may include resisters and capacitors coupled to a harvester 512, a receiver 514, and a controller 506. The controller 506 may be coupled to the switch 508, the harvester 512 and the receiver 514. One node of the switch 508 may be coupled to the controller 506 via a transmission line 520. The controller 506 may control the switch 508 to make connections between a reference voltage 522 (e.g., a ground node) and the antenna 518 as shown in FIG. 5A or disconnect the reference voltage 522 (e.g., a ground node) from the antenna 518 as shown in FIG. 5B. In some examples, the controller 506 may control the switch 508 in accordance with data provided to the controller 506. The switch 508 may accordingly provide different voltage levels to the output node 504 that is coupled to the antenna 518 depending on either an on state or an off state of the switch 508 in some examples. The components shown in FIGS. 5A and 5B are merely exemplary. Additional, fewer, and/or different components may be used in other examples.

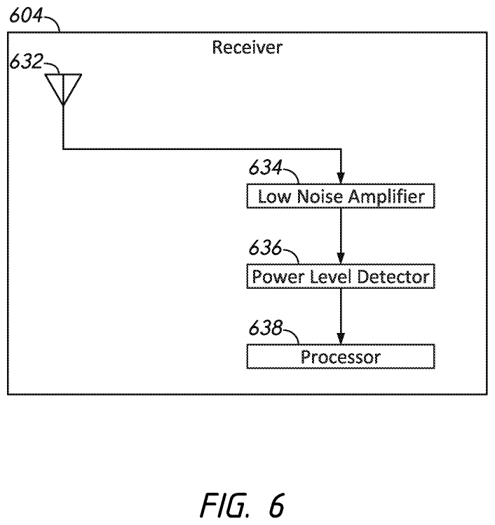

Generally, the transmitter 502 may communicate data with a data reader, such as a receiver 604 of FIG. 6 wirelessly or by way of wire, using either backscattering or a modulated noise communication (MNC) technique. In case of unavailability of a carrier signal for backscattering, an RFID tag including the transmitter 502 may communicate the data using thermal noise using the MNC technique. Examples described herein, such as a system including the transmitter 502 and the receiver 604, may take advantage of thermal noise to wirelessly transmit data from the transmitter 502 to the receiver 604. However, the transmission is not limited to wireless transmission.

In some examples, the transmitter 502 may communicate data by modulating thermal noise associated with one or more electrical components, such as one or more electronic components 516 of the transmitter 502, in accordance with examples described herein. Detailed description of example mathematical aspects of thermal noise and components therein that have been previously described referring to the list 400 of equations in FIG. 4 is therefore not repeated herein for brevity. The electronic components 516 may accordingly be implemented by one or more resistors, conductors, inductors, or generally any component having an impedance.

In FIGS. 5A and 5B, one node of the switch 508 may be coupled to a node at a ground level. Although not illustrated as such, instead of being coupled to a node at a ground level, the switch 508 may be coupled to another reference node, such as a direct current (DC) voltage node, such as a VDD node, a VCC node, or a node with a negative DC voltage. Therefore, the illustrated coupling of the switch 508 to the node at the ground level is a non-limiting example design. The one or more electronic components 516 may be a resistor (R); a diode; a transistor; a network of inductors (Ls), capacitors (Cs), and/or resistors (Rs); and/or any other electronic components that include a resistance (or an impedance).

In some examples, the one or more electronic components 516 may be implemented using a resistance that may be implemented in a variety of ways. For example, the resistance (e.g., the electronic components 516) may be implemented in an integrated circuit (IC). As another example, the resistance may be implemented using one or more diodes. As another example, the resistance may be implemented as a Schottky diode (e.g., a metal-semiconductor junction). As another example, the resistance may be implemented as a diode-connected transistor or a transistor having another configuration. Detailed description of physical, chemical and/or material properties of electronic components 516 using a resistance that have been previously described referring to the electronic component 106 of FIG. 1, is therefore not repeated herein for brevity.

The resistance (or the impedance) of the one or more electronic components 516 causes thermal noise within the transmitter 502. The transmitter 502 may include a harvester 512 that may collect energy based on thermal noise. In some examples, the harvester 512 may include one or more photovoltaic cells. In some examples, the thermal noise includes thermal noise caused by the electronic components 516 coupled to the harvester 512. In some examples, the one or more electronic components 516 may further include the switch 508 and the thermal noise may be affected by the switch 508.

In some examples, a value of the thermal noise power Pₙ (or an absolute value thereof |Pₙ|) corresponds to a value of a signal intensity, where the signal intensity may be expressed using arbitrary units (a.u.). Therefore, the absolute value of the maximum thermal noise power transmitted by the transmitter 502 may correspond to a maximum value of the signal intensity transmitted by the transmitter 502. On the other hand, the absolute value of the minimum thermal noise power transmitted by the transmitter 502 may correspond to the minimum value of the signal intensity.

As described, however, the value of the thermal noise power or the value of the signal intensity changes depending on connection or disconnection of the reference voltage 522 to the transmission line 520 to the electronic components 516 and the transmit antenna 518. Accordingly, examples of systems and methods described herein may utilize a switch which may have multiple states. Each state of the switch may result in a different impedance presented to an antenna of the transmitter and, accordingly, a different transmitted signal intensity. While examples described herein may generally include two states of the switch, other numbers of states may be used in other examples, including three, four, five, or another number of states.

In some examples, the transmitter 502 may modulate information bits by selectively coupling the output node 504 and a resistor load (e.g., the one or more electronic components 516) to a short circuit to the reference voltage 522 (e.g., a ground connection or a shunt). In such a case, the transmitter 502 may transmit a first value of thermal noise power (e.g., a first value of signal intensity) when the reference voltage 522 is electrically disconnected (e.g., decoupled) from the output node 504, and the transmitter 502 may transmit a second value of thermal noise power (e.g., a second value signal intensity) when the output node 504 is coupled to the reference voltage 522. In some examples, the absolute value of the first value may be higher than the absolute value of the second value. In some examples, the absolute value of the thermal noise power transmitted by the transmitter 502 may depend on a size of a capacitor coupled between one node of the switch 508 and the reference voltage 522. For example, if a size of a capacitor is larger, the thermal noise may be smaller.

In some examples, the transmitter 502 may use the switch 508 to selectively choose connection to or disconnection from the short circuit to the reference voltage 522. In some examples, the switch 508 may be an RF switch. In some examples, the switch 508 may include one or more transistors. In some examples, the switch 508 may be an electro-mechanical switch, a relay, a micro-fabricated (e.g., MEMS) switch, or combinations of any of the described components having resistance(s). In some examples, the switch 508 may be, or may effectively operate as, an SPST switch. In some examples, the switch 508 may be designed to prevent its thermal noise. In some examples, the switch 508 may be designed to consider its thermal noise as at least a portion of energy source for transmission. Regardless of the design and/or the technology used to implement the switch 508, the switch 508 may selectively change between the connection and disconnection of the reference voltage 522 to/from the output node 504 and the transmission line 520.

In some examples, the transmitter 502 may transmit different thermal noise powers or signal intensities by selecting between the connection to and disconnection from the reference voltage 522. Thus, the transmitter 502 may modulate information bits by switching connection to or disconnection from the reference voltage 522, where each bit of the information bits may include a first binary value or a second binary value. Generally, the transmitter 502 may modulate information bits by presenting a first voltage to the output node 504 or a second voltage (e.g., a reference voltage) to the output node 504. The first voltage may differ, depending on the presence of an external signal (e.g., a carrier signal from a receiver, a non-carrier signal from a receiver, a radio signal from TV towers or radio towers, or other ambient backscatter generators) as an energy source for backscattering, or absence of the external signal where the transmitter 502 may modulate thermal noise within the electronic components 516, including Johnson noise. Thus, while the first voltage may differ, an RFID tag including the transmitter 502 may provide the data regardless of whether any energy source for providing an interrogating carrier signal is available.

The transmitter 502 may communicate data by modulating thermal noise associated with one or more electrical components, such as one or more electronic components 516. In some examples, the one or more electronic components 516 may include resistors, such as diodes, and capacitors coupled to the receiver 514 and the harvester 512. The receiver 514 may receive an external signal from a data reader, such as the receiver 604 of FIG. 6. In some examples, the received external signal may cause thermal noise within the one or more electronic components 516, and the harvester 512 may harvest energy based on thermal noise, including the thermal noise caused by the external signal. In some examples, the external signal from the data reader, such as the receiver 604 of FIG. 6 may be indicative of a thermal noise mode, and the controller 506 may use energy based on thermal noise harvested by the harvester 512, regardless of presence of any backscatter generators around the transmitter 502. In some examples, the receiver 514 or the harvester 512 may detect whether the external signal includes a carrier signal, and modulate the thermal noise to provide the signal representing data responsive to the external signal upon detecting that the carrier signal is absent in the external signal. In some examples, the controller 506 may use a time-multiplexed continuous wave signal from the data reader. The controller 506 may control the switch 508 in a manner that transmission of the signal is performed when the external signal being a time-multiplexed continuous wave signal is absent (e.g., during an inactive period when the data reader is not sending any communication and listening to a signal transmitted from the transmitter 502). The use of time multiplexing may prevent self-interference by the data reader. In some examples, the controller 506 may use a frequency-multiplexed communication. The transmitter 502 may include an additional antenna that uses a frequency different from a frequency of the external signal. The bidirectional communication can be performed by separate frequencies for transmission and reception between the transmitter 502 and the data reader, that may be free from self-interference by the data reader, unlike a conventional RFID communication.

Digital logic, such as the controller 506 of FIGS. 5A and 5B, may be used to control the switch 508 to couple the reference voltage 522 to or decouple from the electronic components 516 and the output node 504. Either the first value or the second value of thermal noise power may be transmitted by either coupling the reference voltage 522 to or decoupling the reference voltage 522 from the electronic components 516 and the output node 504. In some examples, the controller 506 may provide a control signal, which is provided to (e.g., selectively controls) the switch 508. For example, the switch 508 may be in a first state or a second state responsive to a first level or a second level of the control signal. The controller 506 may control the switch 508 in accordance with data intended for transmission. In some examples, the controller 506 may include circuitry, microcontroller(s), and/or processor(s). The controller 506 may include a subcarrier generator to generate a subcarrier frequency, such as a square-wave subcarrier frequency as previously described referring to the subcarrier generator 120 of FIG. 1. Thus, detailed description of the subcarrier generator is not repeated herein for brevity.

In some examples, to transmit a digital (e.g., a binary) level or value (e.g., a “0”) in the data, the controller 506 may provide the control signal to control the switch 508 to couple the reference voltage 522. To transmit another digital level (e.g., a “1”), the controller 506 may provide the control signal to control the switch 508 to decouple the output node 504 from the reference voltage 522. For example, the switch 508 may switch, couple, and decouple the reference voltage 522 at the subcarrier frequency (e.g., at the square-wave subcarrier frequency of FIG. 2A).

The transmitter 502 may transmit data. The data may generally be representative of any information. For example, the data may be an identification string, such as information that may be provided by an RFID tag. Other data may be used in other examples. In some examples, the data may be stored in a computer-readable medium (not illustrated). In some examples, the computer-readable medium may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth.

It is to be understood, however, that the transmitter 502 may be less complex and/or may consume less power than a conventional RFID tag. For example, the conventional RFID tag requires generation of a carrier and the receiver may need to account for self-interference. By contrast, the transmitter 502 may transmit digital information using thermal noise regardless of availability of a carrier or pre-existing RF signal without self-interference.

Accordingly, examples described herein include RFID tags which may transmit data responsive to interrogation with a carrier wave, and may utilize the carrier wave to backscatter the data of the RFID tag, but may additionally or instead transmit data using modulated noise of one or more components on the tag. In this manner, RFID tags may be read by receiving signals including modulated noise (e.g., thermal noise) of the tag.

FIG. 6 is a schematic diagram of a receiver 604, in accordance with examples described herein. The receiver 604 may be used to receive (e.g., decode) transmissions sent by transmitters described herein, to recover data.

Generally, the receiver 604 may communicate command and data with a transmitter, such as the transmitter 502 of FIGS. 5A and 5B, wirelessly or by way of wire, using either backscattering or an MNC technique. Examples described herein, such as a system including the transmitter 502 and the receiver 604, may take advantage of thermal noise to wirelessly transmit data from the transmitter 502 to the receiver 604 using the MNC technique. However, the transmission is not limited to wireless transmission described herein.

In some examples, the receiver 604 may include one or more antennae 632, at least one low noise amplifier 634, a power level detector 636, and a processor 638. In some examples, the one or more antennae 632 may include antennae that may receive different intensity ranges of signals, such as signals transmitted by backscattering and signals transmitted by MNC based on thermal noise in a transmitter. In some examples, one of the one or more antennae 632 may be designed for receiving the backscattering signals and another one of the one or more antennae 632 may be designed for receiving the MNC signals. In some examples, one of the one or more antennae 632 may be designed for receiving a broad range of intensity of signals, including the backscattering signals and the MNC signals. The composition, material, design, and/or size of antennae may vary.

In some examples, the antennae 632 may be coupled to the low noise amplifier 634. The low noise amplifier 634 may amplify either a backscattering signal or an MNC signal being received by the one or more antennae 632, while maintaining a good signal-to-noise ratio (SNR). In some examples, in addition to the low noise amplifier 634, the receiver 604 may also include a bandpass filter (not illustrated) and another low noise amplifier (not illustrated), where the bandpass filter may be coupled between the low noise amplifier 634 and the other low noise amplifier. Generally, the two low noise amplifiers may be implemented using two high-gain low noise amplifiers. If the receiver 604 utilizes the bandpass filter, the bandpass filter may prevent and/or reduce feedback oscillation and/or reduce the effect of interfering signals, as described herein. The power level detector 636 may be coupled to the one or more low noise amplifiers 634.

The receiver 604 may include at least one power level detector 636. In some examples, the receiver 604 may include two or more power level detectors 636. In some examples, the at least one power level detector 636 may detect power fluctuations of the MNC signal based on thermal noise or power fluctuations of the backscattering noise based on a carrier signal from the receiver 604 or some other ambient RF signal. In some examples, the at least one power level detector 636 may detect power fluctuations based on a power level range of the MNC signal that is smaller than a power level range of the backscattering signal. In some examples, the receiver 604 may include each power level detector 636 for each corresponding power level range of the transmitted signal. In some examples, the receiver 604 may perform a heterodyne detection of the data.

The power level detector 636 may be implemented using hardware, software, firmware, or a combination thereof. For example, the power level detector 636 may include RF hardware, such as a diode rectifier, an envelope follower, an amplifier, an analog-to-digital converter (ADC), a tuner (e.g., a multiplier), a low pass filter, or a combination thereof that are capable of measuring signal power or strength, such as the thermal noise power Pₙ.

In some examples, the power level detector 636 may be or may include a software defined radio. The software defined radio (e.g., the power level detector 636) may be coupled to the low noise amplifier 634 (or the second low noise amplifier) and may be provided with amplified signals received by the low noise amplifier. In some examples, the software defined radio may convert either the received backscattering signal or the MNC signal received from the transmitter 502 down to a baseband signal. In some examples, the software defined radio may adjust a target power level range to detect either the backscattering signal or the MNC signal. The software defined radio may then digitize the baseband signal. The baseband signal of the software defined radio may then be processed by the processor 638 to recover data transmitted by one or more transmitters described herein. In some examples, the software defined radio may process either time-multiplexed or frequency-multiplexed signals, thus the reader for MNC may be free from self-interference.

In some examples, the processor 638 is coupled to the power level detector 136, and the processor 638 may be substantially any electronic device that may be capable of processing, receiving, and/or transmitting signals and/or instructions (e.g., code). In aspects, the processor 638 may be implemented using one or more of a central processing unit (CPU), a graphic processing unit (GPU), a microcontroller unit (MCU), an application specific integrated circuit (ASIC), a field programmable gate array (FPGA), a microprocessor, a microcomputer, and/or other circuitry. The processor 638 may receive signals from the power level detector 636 and extract data packets from the received signals.

Accordingly, methods of transmitting a signal including modulating thermal noise in a transmitter based on data to provide a signal and transmitting the signal including the data as output of the transmitter may be provided in accordance with examples described herein. Accordingly, a transmitter may transmit a data signal in absence of a carrier signal or other RF signal.

From the foregoing it will be appreciated that, although specific embodiments of the disclosure have been described herein for purposes of illustration, various modifications may be made without deviating from the spirit and scope of the disclosure.

The particulars shown herein are by way of example and for purposes of illustrative discussion of the preferred embodiments of the present disclosure.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

Of course, it is to be appreciated that any one of the examples, embodiments, or processes described herein may be combined with one or more other examples, embodiments, and/or processes or be separated and/or performed among separate devices or device portions in accordance with the present systems, devices, and methods.

Finally, the above discussion is intended to be merely illustrative of the present method, system, device, and computer-readable medium and should not be construed as limiting the appended claims to any particular embodiment or group of embodiments. Thus, while the present method, system, device, and computer-readable medium have been described in particular detail with reference to exemplary embodiments, it should also be appreciated that numerous modifications and alternative embodiments may be devised by those having ordinary skill in the art without departing from the broader and intended spirit and scope of the present method, system, device, and computer-readable medium as set forth in the claims that follow.

Accordingly, the specification and drawings are to be regarded in an illustrative manner and are not intended to limit the scope of the appended claims.

What is claimed is:

1. A method comprising:
modulating thermal noise in a transmitter based on data to provide a signal; and
transmitting the signal including the data as output of the transmitter.

2. The method of claim 1, wherein the transmitter comprises an antenna, and
wherein said transmitting the signal is performed wirelessly using the antenna.

3. The method of claim 1, wherein said modulating the thermal noise comprises modulating a signal intensity of the signal at least in part based on the data.

4. The method of claim 3, further comprising:
coupling an output node of the transmitter to at least one electronic component in the transmitter responsive to each bit of the data having a first binary value; and
decoupling the output node from the electronic component responsive to each bit of data having a second binary value,
wherein the thermal noise comprises thermal noise of the at least one electronic component.

5. The method of claim 4, wherein said decoupling comprises coupling the output node to a reference voltage.

6. The method of claim 4, wherein a first impedance of the transmitter to the output node when the output node is coupled to the at least one electronic component is a closer impedance match than a second impedance of the transmitter to the output node when the output node is decoupled from the at least one electronic component.

7. The method of claim 1, further comprising receiving an external signal from a receiver,
wherein the thermal noise comprises thermal noise based on the external signal.

8. The method of claim 7, further comprising: receiving an external signal from a receiver,
wherein said modulating the thermal noise is responsive to the external signal indicative of a thermal noise mode.

9. The method of claim 1, further comprising:
receiving an external signal from a receiver;
detecting whether the external signal comprises a carrier signal; and
modulating the thermal noise to provide the signal representing data responsive to the external signal upon detecting that the carrier signal is absent in the external signal.

10. The method of claim 9, wherein the signal provided by modulating the thermal noise has a lower signal intensity than the signal provided by modulating the external signal.

11. The method of claim 9, further comprising transmitting the signal when the external signal being a time-multiplexed continuous wave signal is absent.

12. The method of claim 9, further comprising transmitting the signal at a frequency different from a frequency of the external signal.

13. An apparatus comprising:
at least one electronic component;
a controller configured to modulate thermal noise from the at least one electronic component to provide a signal representing data; and
a transmitter configured to transmit the signal at an output node.

14. The apparatus of claim 13, wherein the electronic component comprises a resistor.

15. The apparatus of claim 13, wherein the controller comprises a subcarrier generator configured to generate a subcarrier frequency, and
wherein the controller is configured to modulate the thermal noise further based on the subcarrier frequency.

16. The apparatus of claim 13, further comprising an antenna coupled to the output node,
wherein the transmitter is configured to wirelessly transmit the signal through the antenna.

17. The apparatus of claim 13, further comprising a harvester configured to harvest energy and further configured to provide power based on the harvested energy,
wherein the controller is configured to modulate the power to provide the signal representing the data.

18. The apparatus of claim 17, wherein the harvester comprises one or more photovoltaic cells.

19. The apparatus of claim 13, further comprising:
a switch coupled to the output node,
wherein the controller is configured to provide a control signal based on each bit of the data, and
wherein the switch is configured to couple the output node to the at least one electronic component responsive to the control signal based on each bit of the data having a first binary value in a first state, and further configured to decouple the output node from the at least one electronic component responsive to the control signal based on each bit of data having a second binary value in a second state.

20. The apparatus of claim 19, wherein the switch is configured to selectively change an impedance matching of the apparatus responsive to the control signal.

21. The apparatus of claim 19, wherein the at least one electronic component is coupled between the switch and a reference voltage node.

22. The apparatus of claim 19, wherein the switch is configured to decouple the electronic component from the output node when the switch is in the first state, and further configured to couple the electronic component to the output node when the switch is in the second state.

23. The apparatus of claim 19, wherein the switch is further configured to couple the output node to a reference voltage when the switch is in the first state.

24. The apparatus of claim 19, wherein the thermal noise comprises thermal noise caused by a harvester configured to harvest energy.

25. The apparatus of claim 13, further comprising a receiver configured to receive an external signal,
wherein the controller is configured to modulate the thermal noise to provide the signal representing the data responsive to the external signal indicative of a thermal noise mode, and
wherein the controller is further configured to modulate a carrier signal in the external signal to provide a signal representing the data responsive to the external signal indicative of a radio frequency mode.

26. The apparatus of claim 25, wherein the external signal is a time-multiplexed continuous wave signal, and
wherein the transmitter is configured to provide the signal representing the data while the external signal is absent.

27. An apparatus comprising:
a first receiver circuity comprising a first antenna configured to receive a first signal;
a second receiver circuity comprising a second antenna configured to receive a second signal; and
at least one power level detector configured to digitize a signal based on the first signal or the second signal into a digital signal,
wherein the at least one power level detector is configured to detect power fluctuations based on a power level range of the second signal that is smaller than a power level range of the first signal.

28. The apparatus of claim 27, wherein each receiver circuitry further comprises:
a low noise amplifier coupled to at least one of the first antenna and the second antenna, the low noise amplifier configured to amplify the received signal; and
a processor configured to decode the digital signal to provide data,
wherein the amplified signal is the signal based on the first signal or the second signal.

29. The apparatus of claim 27, wherein the at least one power level detector is configured to perform a heterodyne detection of the data.

30. A system comprising:
a transmitter configured to transmit a signal with data by using a subcarrier frequency, wherein the transmitter is configured to modulate a thermal noise of the transmitter and modulate a signal intensity of the transmitted signal in accordance with the data; and
a receiver configured to receive the signal with the data by using the subcarrier frequency, wherein the receiver is configured to demodulate the signal intensity of the received signal with the data by comparing the signal intensity to a threshold signal intensity.

31. The system of claim 30, wherein the transmitter comprises:
at least one electronic component; and
a controller configured to modulate thermal noise from the at least one electronic component to provide a signal representing data.

32. The system of claim 30, wherein the receiver comprises:
a first receiver circuity comprising a first antenna configured to receive a first signal;
a second receiver circuity comprising a second antenna configured to receive a second signal; and
at least one power level detector configured to digitize a signal based on the first signal or the second signal into a digital signal,
wherein the at least one power level detector is configured to detect power fluctuations based on a power level range of the second signal that is smaller than a power level range of the first signal.
